(19) United States
(12) Patent Application Publication
(10) Pub. No.: US 2003/0208955 A1
(43) Pub. Date: Nov. 13, 2003

(54) Narrow-neck floral sleeve

(75) Inventor: Donald E. Weder, Highland, IL (US)

Correspondence Address: DUNLAP, CODDING & ROGERS P.C., PO BOX 16370, OKLAHOMA CITY, OK, 73113, US

(73) Assignee: SOUTHPAC TRUST INTERNATIONAL, INC.

(21) Appl. No.: 10/145,126

(22) Filed: May 13, 2002

(51) Int. Cl. A01G 5/00; A47G 7/00

(52) U.S. Cl. 47/41.01

(57) ABSTRACT

A floral sleeve having a flask-shape with a frustoconical body and a narrow neck. The sleeves may have various types of gusseted or non-gusseted lower end shapes, various types of neck shapes, and may be secured, or left unsecured about the floral groupings placed within the sleeves.

### CROSS REFERENCE TO RELATED APPLICATIONS

Not applicable.

### FIELD OF THE INVENTION

This invention generally relates to sleeves, and more particularly, to sleeves used to contain floral groupings and/or mediums containing floral groupings, and methods of using same.

### BRIEF DESCRIPTION OF THE DRAWINGS

FIG. 1 is an elevational view of a sleeve constructed in accordance with the present invention.

FIG. 2 is a perspective view of the sleeve of FIG. 1 in an opened condition and having a floral grouping and a ballast material disposed therein.

FIG. 3 is a perspective view of an alternative sleeve embodiment having a floral grouping disposed therein and with the neck of the sleeve crimped about the floral grouping.

FIG. 4 is a perspective view of the sleeve of FIG. 1 having a floral grouping therein with the neck of sleeve constricted about the floral grouping via a banding element.

FIG. 5 is an elevational view of another sleeve constructed in accordance with the present invention.

FIG. 6 is an elevational view of another sleeve constructed in accordance with the present invention, the sleeve having a gusset in a lower end thereof.

FIG. 7 is an elevational view of another embodiment of a sleeve constructed in accordance with the present invention and having an inwardly-curved lower end.

FIG. 8 is an elevational view of another embodiment of a sleeve constructed in accordance with the present invention and having an outwardly-curved lower-end.

FIG. 9 is an elevational view of another embodiment of a sleeve constructed in accordance with the present invention and having an outwardly-curved lower end and a gusset therein.

FIG. 10 is an elevational view of another embodiment of a sleeve constructed in accordance with the present invention and having a frustoconical neck.

### DESCRIPTION OF THE PREFERRED EMBODIMENTS

The present invention contemplates in a preferred version a flask-shaped sleeve (also referred to herein simply as a “sleeve”) which is sized to contain a floral grouping alone or a floral grouping with a ballast material such as a growing medium. The sleeve has a narrow neck at an upper end of a body thereof.

Various embodiments of the flask-shaped sleeve having the narrow neck are now described in more detail below. It will be understood that the examples provided herein are not intended to limit the scope and extent of the claimed invention but are only intended to exemplify various embodiments of the invention contemplated herein.

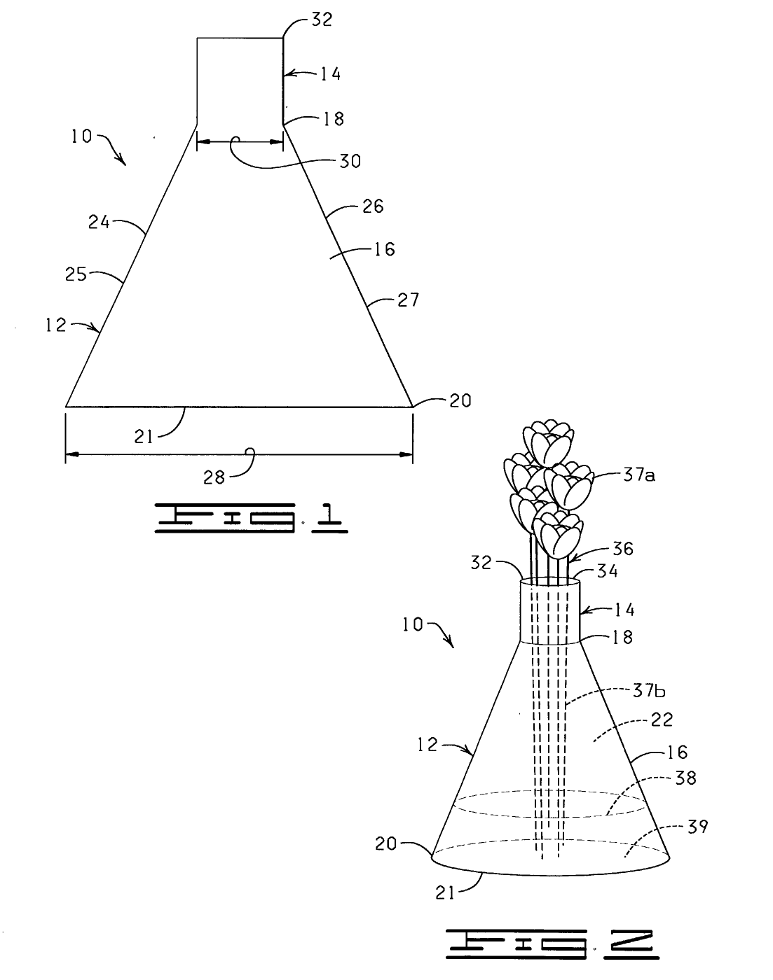

Turning now to the drawings, shown in FIGS. 1, 2 and 4 is a sleeve designated by the general reference numeral 10. Sleeve 10 has a body 12 and a neck 14. The body 12 has a sidewall 16, an upper end 18, and a lower end 20 having a horizontal transverse seal 21, and an inner space 22. The sidewall 16 has a first edge 24 having a first edge seal 25 and a second edge 26 having a second edge seal 27 since the sleeve 10 is initially constructed in a flattened condition (FIG. 1). The body 12 of the sleeve 10 preferably has a frustoconical shape having a shape of a flask, such as an Erlenmeyer flask. The body 12 has a wide diameter 28 in the lower end 20 between the first edge 24 and the second edge 26, and a narrow diameter 30 in the upper end 18 between the first edge 24 and the second edge 26. The sleeve 10 is initially formed in a flattened condition and is openable therefrom to an opened state for containing a floral grouping as described elsewhere herein.

The neck 14 has an upper end 32 and extends from the upper end 18 of body 12 and has an opening 34. The neck 14 communicates with the inner space 22 of the body 12, and in a preferred embodiment has a substantially cylindrical shape when the sleeve 10 is in the opened condition as shown in FIG. 2. As shown in FIG. 2, a floral grouping 36 has been disposed within the inner space 22 by inserting a stem portion 37b of the floral grouping 36 through the neck 14. As shown in FIG. 2, the floral grouping 36 preferably also has a bloom portion 37a. A ballast material 38 may also be disposed into the inner space 22. The ballast material 38 may be a liquid such as water or a semi-solid material such as a gel. Alternatively, the ballast material 38 may be a growing medium such as dirt, sand, humus, compost, fibrous organic material such as peat moss, foam pellets, perlite, vermiculite, or any other organic, mineral, natural or synthetic material used in the floral industry as a growing medium. When the sleeve 10 is in the opened condition, and the lower end 20 is expanded, a bottom 39 is formed in the lower end 20 of the body 12. The bottom 39 may comprise overlapping portions of the body 12, or may be substantially flat when the lower end 20 of the body 12 has a gusset therein, for forming the bottom 39, as discussed in more detail below.

An alternative embodiment of the present invention is the sleeve designated by the general reference numeral 10a shown in FIG. 3. Like sleeve 10, sleeve 10a as shown in FIG. 3 has a body 12a and a neck 14a. The body 12a has a sidewall 16a, an upper end 18a, a lower end 20a, and an inner space 22a, and a bottom 39a in the opened position. Sleeve 10a further comprises a bonding material 40 disposed upon a portion thereof on or near the neck 14a. The bonding material 40 may be an adhesive or cohesive bonding material for example and may have a release material (not shown) thereon for covering the bonding material 40 until the sleeve 10a is ready for use.

After the sleeve 10a has been expanded into the opened position, and the floral grouping 36 disposed therein, a constricted area 42 can be manually or automatically formed in a portion of the neck 14a by crimping the portion of the sleeve 10a having the bonding material 40 thereon, the constricted area 42 serving to secure the sleeve 10a about the stem portion 37b or bloom portion 37a of the floral grouping 36.

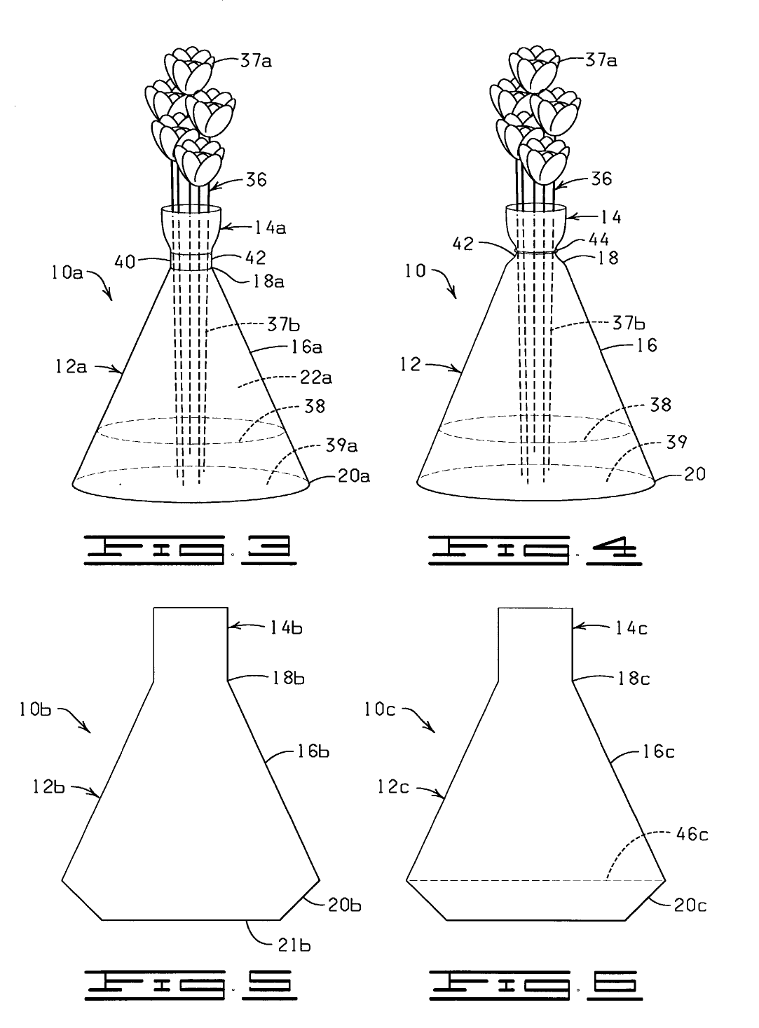

Sleeve 10 can also be secured about the floral grouping 36 in a manner similar to sleeve 10a. As shown in FIG. 4, a banding element 44 (also referred to herein as a securing element) can be placed about a portion of the neck 14 or near the upper end 18 of the body 12 to form a constricted area 42 in the sleeve 10 to secure the sleeve 10 about a portion of the floral grouping 36, for example about the stem portion 37b of the floral grouping 36. The banding element 44 can be any device which can be placed about a portion of the sleeve 10 and can securely form the constricted area 42, including an elastic or rubber band, a string, a tie, a wire, a ribbon, a heat shrinkable band or tape, a staple, a clip, a plastic tie, a plastic wire, a metal wire, or an adhesive tape, for example.

Shown in FIG. 5 is a sleeve designated by the general reference numeral 10b. Sleeve 10b has a body 12b and a neck 14b. The body 12b has a sidewall 16b, an upper end 18b, and a lower end 20b. Sleeve 10b is similar to either sleeve 10 or 10a, except the lower end 20b of sleeve 10b has a half-hexagonal shape having a half-hexagonal seal 21b rather than a completely straight seal. Sleeve 10b can be modified to be like sleeve 10a and can be used like sleeve 10 in the manners shown in FIGS. 2 or 4.

Shown in FIG. 6 is a sleeve designated by the general reference numeral 10c. Sleeve 10c has a body 12c and a neck 14c. The body 12c has a sidewall 16c, an upper end 18c, and a lower end 20c. Sleeve 10c is similar to any of sleeves 10-10b described herein except the lower end 20c of sleeve 10c has a half-hexagonal shape having a gusset 46c therein which enables the sleeve 10c to be opened to have a substantially flat bottom (not shown) when in the opened position. Methods of making such gussets 46c are well known in the art. Sleeve 10c can be used or modified like any of sleeves 10-10b.

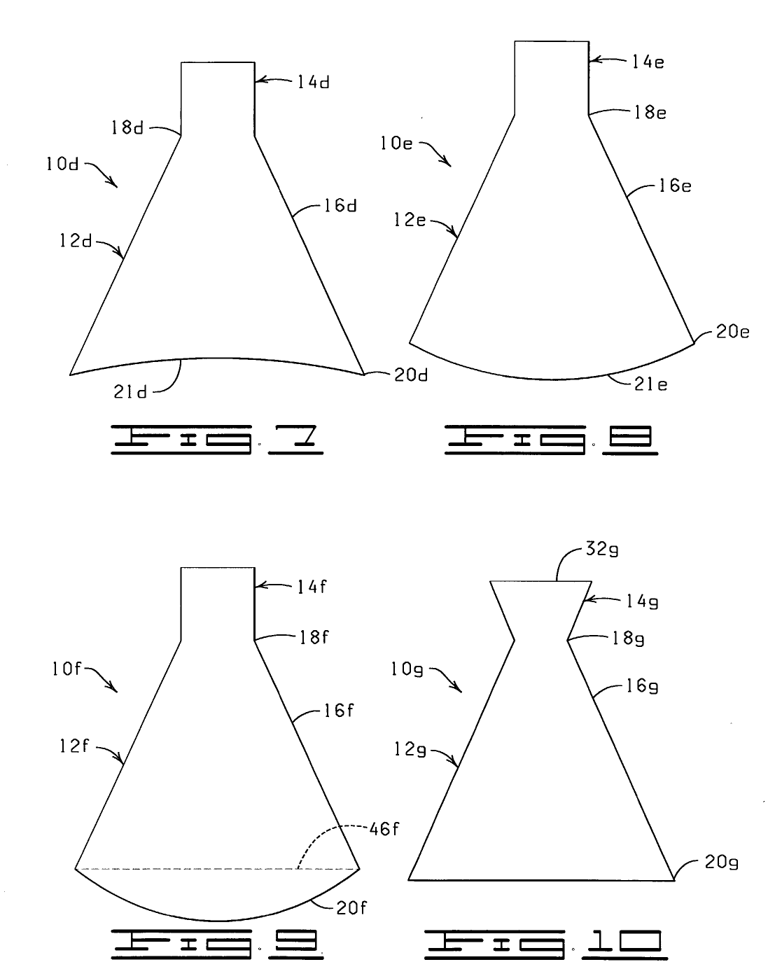

Shown in FIG. 7 is a sleeve designated by the general reference numeral 10d. Sleeve 10d has a body 12d and a neck 14d. The body 12d has a sidewall 16d, an upper end 18d, and a lower end 20d. Sleeve 10d is similar to any of sleeves 10-10c, and can be modified or used like any of sleeves 10-10c except the lower end 20d of sleeve 10d has a concave or inwardly-curved shape and has an inwardly-curved seal 21d.

Shown in FIG. 8 is a sleeve designated by the general reference numeral 10e. Sleeve 10e has a body 12e and a neck 14e. The body 12e has a sidewall 16e, an upper end 18e, and a lower end 20e. Sleeve 10e is similar to any of sleeves 10-10d and can be modified or used like any of sleeves 10-10d except the lower end 20e of sleeve 10e has a convex or outwardly-curved shape and has an outwardly-curved seal 21e.

Shown in FIG. 9 is a sleeve designated by the general reference numeral 10f. Sleeve 10f has a body 12f and a neck 14f. The body 12f has a sidewall 16f, an upper end 18f, and a lower end 20f. Sleeve 10f is similar to any of sleeves 10-10e and can be modified or used like any of sleeves 10-10e except the lower end 20f of sleeve 10f has an outwardly-curved, or convexly shaped lower end which also has a gusset 46f therein. The method of manufacturing such gussets 46f in sleeves having convexly-curved lower ends are know in the art and are shown for example in U.S. Pat. No. 6,182,395, the specification and drawings of which are each hereby expressly incorporated herein by reference in their entirety.

Shown in FIG. 10 is a sleeve designated by the general reference numeral 10g. Sleeve 10g has a body 12g and a neck 14g. The body 12g has a sidewall 16g, an upper end 18g, and a lower end 20g. The neck 14g has an upper end 32g. Sleeve 10g is similar to any of sleeves 10-10f and can be modified or used like any of sleeves 10-10f except the neck 14g, rather than having a cylindrical shape when opened, has a “funnel” or “cone” (frustoconical) shape when opened, wherein a width of the upper end 32g of the neck 14g is wider than a width of the upper end 18g of the body 12g. As noted, any of sleeves 10-10f can be modified to have a neck similar to the neck 18g of sleeve 10g.

Any of the sleeves 10-10g contemplated herein may also be equipped with drainage elements (e.g., one or more holes)or ventilation holes or perforations (not shown).

Any thickness of material may be utilized to construct sleeves 10-10g as long as the sleeves 10-10g may be formed as described herein, and as long as the formed sleeves 10-10g may contain at least a portion of the floral grouping 36, as described herein. Additionally, an insulating material such as bubble film, preferable as one of two or more layers, can be utilized in order to provide additional protection for the item, such as the floral grouping 36, contained therein.

The material from which the sleeves 10-10g described herein are constructed preferably has a thickness in a range from about 0.1 mil to about 30 mils. Often, the thicknesses of the sleeves 10-10g are in a range from about 0.5 mil to about 10 mils or preferably, in a range from about 1.0 mil to about 5 mils. More preferably, the sleeves 10-10g are constructed from a material which is flexible, semi-rigid, rigid, or any combination thereof. The sleeves 10-10g may be constructed of a single layer of material or a plurality of layers of the same or different types of materials. The layers of material comprising the sleeves 10-10g may be connected together or laminated or may be separate layers. Such materials used to construct the sleeves 10-10g are similar to those described in U.S. Pat. No. 5,111,637, which is hereby expressly incorporated herein by reference.

The sleeves 10-10g are constructed from any suitable material that is capable of being formed into a sleeve and used to contain a floral grouping disposed therein. Preferably, the material comprises treated or untreated paper, metal foil, polymeric film, non-polymeric film, woven or nonwoven fabric, or synthetic or natural fabric, cardboard, fiber, cloth, burlap, or laminations or combinations thereof.

In one embodiment, the sleeves 10-10g contemplated herein may be constructed from sheets comprising two polypropylene films. The two polypropylene films comprising the sleeves 10-10g may be connected together or laminated or may be separate layers. In an alternative embodiment, the sleeves 10-10g may be constructed from only one sheet of the polypropylene film.

The sleeves 10-10g formed as described herein are preferably liquid impermeable. Methods and materials for making the sleeves 10-10g liquid impermeable are shown in pending U.S. Ser. No. 09/847,730 filed May 2, 2001, the specification of which is hereby expressly incorporated herein by reference in its entirety. The term “liquid impermeable” as used herein means that liquid contained within the sleeves 10-10g will be retained therein and will not leak through either the sheet of liquid impermeable material from which the sleeves 10-10g are constructed or through the seals of the closed lower ends 20-20g or through the seals of the sidewalls 16-16g of the sleeves 10-10g. The term “liquid impermeable” may be used interchangeably with the terms “leak proof”, “leak resistant”, “fluid impermeable” and “watertight”.

As noted, the sheet of liquid impermeable material from which the sleeves 10-10g are preferably constructed should be liquid impermeable and must be capable of being formed into a sleeve 10-10g which can be used to contain a floral grouping. The sheet of liquid impermeable material from which the sleeves 10-10g are formed is desirably constructed of two or more layers of materials, such as two sheets of polymeric film, wherein one of the layers of material has a lower melting temperature than the other layer of material such that upon forming an overlapping portion of the sheet of liquid impermeable material into a seal of the lower ends 20-20g and an overlapping portion of the sheet of material into the seals of the sidewalls 16-16g of the sleeves 10-10g, wherein the layer of material which has a lower melting temperature will flow into any voids or micropores formed within the seal in the other layer of material to render the seals liquid impermeable (i.e., leak proof).

The term “polymeric film” as used herein will be understood to include synthetic polymers such as polypropylene or polyethylene as well as naturally occurring polymers such as cellophane. A polymeric film is relatively strong and not as subject to tearing (substantially non-tearable), as might be the case with paper or foil. Preferred examples of such polymeric films include high density polyethylene (HDPE), low density polyethylene (LDPE), linear low density polyethylene (LLDPE), oriented polypropylene (OPP), biaxially oriented polypropylene (BOPP), cast polypropylene (CPP), ethyl vinyl acetate (EVA), polyvinyl choride (PVC), polyvinylidene chloride (PVDC), ethylene vinyl alcohol (EVOH), polystyrene (PS), or polyethylene terephthlate (PET).

Preferably, the sleeves 10-10g are constructed of a laminate of two or more layers of polymeric film, such as a laminate formed of BOPP laminated to HDPE, LDPE or LLDPE. Such materials provide a necessary stiffness without excessive thickness and will still provide adequate sealing for waterproof and strength requirements. Examples of preferred laminated materials which can be utilized in accordance with the present invention include HDPE laminated to clear, coextruded BOPP, HDPE laminated to white, expanded, coextruded BOPP, HDPE laminated to metallized, expanded, coextruded BOPP, HDPE laminated to metallized, coextruded BOPP, HDPE laminated to a clear, white or metallized homopolymer, and CPP laminated to any of the above materials to which laminates to HDPE are described.

Preferably, the first layer of material is BOPP and the second layer of material is LDPE, LLDPE or HDPE. BOPP is the desired first layer of material for several reasons: (1) BOPP has a stiffness which allows the sleeves 10-10g formed therefrom to hold their shape well even when used at a minimum level of thickness; (2) BOPP is readily available and inexpensive; (3) BOPP is available in a variety of thicknesses and widths; (4) BOPP is available in a crystal clear transparent film; and (5) BOPP can be readily printed and/or metallized. The second layer of material is desirably HDPE, LDPE, or LLDPE because these materials form seals which are more liquid impermeable than BOPP alone and do not have the clarity and gloss of BOPP, nor do they have the stiffness of BOPP. Alternatively, BOPP may be the interior layer and LDPE, LLDPE or HDPE the outer layer, that is, the first layer of material may be LDPE, LLDPE, or HDPE and the second layer of material may be BOPP.

When the sheet of liquid impermeable material from which the sleeves 10-10g are constructed is a laminate of two or more layers of material, one of the layers of material may be liquid impermeable, or neither of the layers of material may be liquid impermeable when used alone, while the laminate formed therefrom is liquid impermeable. Alternatively, both layers of material of the sheet of liquid impermeable material may be liquid impermeable, but when a seal is formed from overlapping portions of one of the layers of material alone, voids or micropores are formed therein which render the seal permeable to liquids. When one of the layers of material of the sheet of liquid impermeable material from which the sleeves 10-10g are constructed is liquid impermeable or when one of the layers of material forms more liquid impermeable seals, the more liquid impermeable layer of material is desirably located adjacent an inner surface of the sidewalls 16-16g and therefore on the inside of the sleeves 10-10g. For example, the sheet of material may be a laminate of BOPP and HDPE, and HDPE may be located adjacent an inner surface of the sidewalls 16-16g of the sleeves 10-10g. However, it will be understood that the more liquid impermeable layer of material of the sheet of liquid impermeable material may also be located adjacent an outer surface of the sidewalls 16-16g and therefore the outside of the sleeves 10-10g.

Alternatively, the sleeves 10-10g may be constructed of a sheet of liquid impermeable material which comprises a sheet of material having an extrusion coating thereon, such as an extrusion coating of a polymeric film with a second polymer. In this instance, the extrusion coating will have a lower melting temperature than the sheet of material of the sheet of liquid impermeable material, and thus will flow into any voids or micropores formed in the adjacent or overlapping portions of the sheet of material which form the seals of the lower ends 20-20g and the seals of the sidewalls 16-16g of the sleeves 10-10g, thereby forming sleeves 10-10g having liquid impermeable seals. By using a more expensive, stronger material for the extrusion coating and only coating the portion of the sheet of liquid impermeable material substantially adjacent the area which will form the seals of the sleeves 10-10g, a less expensive, weaker polymeric film may be used as the sheet of material and will result in sleeves 10-10g possessing the superior seal strength and thus liquid impermeability of the extrusion coating without the expense of extrusion coating the entire surface of the sheet of material. An example of such a sheet of material is BOPP coextruded with LDPE, LLDPE or HDPE.

In yet another alternative, the sleeves 10-10g may be constructed of sheets of liquid impermeable material comprising a sheet of material having a bonding material disposed upon the portion of the sheet of material substantially adjacent the area which will form the seal of the lower ends 20-20g and seals of the sidewalls 16-16g of the sleeves 10-log. The term “bonding material” as used herein includes adhesives, preferably pressure sensitive adhesives, cohesives, heat sealable materials, sonic sealable materials, vibratory sealable materials, and cold seal materials.

As noted above, the sleeves 10-10g described herein and depicted in the figures are preferably formed of a sheet of liquid impermeable material comprising a laminate of two layers of material, i.e., a laminate of BOPP and HDPE. However, it will be understood that the sleeves of the present invention are not limited to construction from a sheet of liquid impermeable material comprising a laminate of two layers but may also be constructed of a sheet of liquid impermeable material comprising only a single layer or comprising a laminate of three or more layers, an extrusion coated material or a material having a bonding material disposed upon a portion thereof.

In addition, the present invention also includes the use of tape having a bonding material disposed thereon to form the seals of the sleeves 10-10g. The tape may be applied over the overlapping portions of the lower ends 20-20g to form the seal and over overlapping portions of the sidewalls 16-16g to form the seals, or folds may be formed in the lower ends 20-20g and/or sidewalls 16-16g prior to overlapping and applying tape thereto to form the seals. That is, the seal in the lower ends 20-20g of the bodies 12-12g may be formed by the application of an extrusion coating to the portion of the sheet of liquid impermeable material forming the seal in the lower ends 20-20g, while the portion of the sheet of liquid impermeable material forming the seals in the sidewalls 16-16g are provided with a bonding material thereon to effect the sealing of the seals. In addition, one of the seals of the sleeves 10-10g may be formed by more than one method of providing a liquid impermeable seal disclosed herein. For example, the portion of the sheet of liquid impermeable material from which the sleeves 10-10g are constructed and which forms the seals in the sidewalls 16-16g may be provided with a bonding material thereon, and following the formation of overlapping portions held together by the bonding material, tape may be applied thereto to ensure the liquid impermeability of the seals of the sidewalls 16-16g of the bodies 12-12g.

As stated above, for the sleeves 10-10g to be liquid impermeable, not only will the sheet of liquid impermeable material from which the sleeves 10-10g are constructed need to be liquid impermeable, but the seal of the lower ends 20-20g and the seals of the sidewalls 16-16g must also be liquid impermeable and must not leak liquid retained in the sleeves 10-10g. To achieve liquid impermeable seals, several methods of sealing may be used as described in more detail in pending U.S. Ser. No. 09/847,730.

The materials comprising the sleeves 10-10g may vary in color and as described herein may consist of designs or decorative patterns which are printed, etched, and/or embossed thereon using inks or other printing materials. An example of an ink which may be applied to the surface of the material is described in U.S. Pat. No. 5,147,706, which is hereby expressly incorporated herein by reference.

In addition, the material may have various colorings, coatings, flocking and/or metallic finishes, or other decorative surface ornamentation applied separately or simultaneously or may be characterized totally or partially by pearlescent, translucent, transparent, iridescent, neon, or the like, qualities. The material may further comprise, or have applied thereto, one or more scents. Each of the above-named characteristics may occur alone or in combination and may be applied to the outer and/or inner peripheral surface of the sleeves 10-10g. Moreover, portions of the material used in constructing the sleeves 10-10g may vary in the combination of such characteristics. The material utilized for the sleeves 10-10g may be opaque, translucent, transparent, or partially clear or tinted transparent.

The term “floral grouping” as used herein generally means cut fresh flowers, artificial flowers, a single flower or other fresh and/or artificial plants or other floral materials and may include other secondary plants and/or ornamentation or artificial or natural materials which add to the aesthetics of the overall “floral grouping”. The floral grouping 36 comprises, as noted above, the bloom (or foliage) portion 37a and the stem portion 37b. Further, the floral grouping 36 may comprise a root portion (not shown) as well. It will be appreciated that the floral grouping 36 may consist of only a single bloom or only foliage, or a botanical item (not shown), or a propagule (not shown). The term “floral grouping” may be used interchangeably herein with the term “floral arrangement”.

The term “growing medium” when used herein means any liquid, solid or gaseous material used for plant growth or for the cultivation of propagules, including organic and inorganic materials such as soil, humus, perlite, vermiculite, sand, water, and including the nutrients, fertilizers or hormones or combinations thereof required by the plants or propagules for growth.

The term “botanical item” may be used interchangeably with the term “floral grouping” and when used herein means a natural or artificial herbaceous or woody plant, taken singly or in combination. The term “botanical item” also means any portion or portions of natural or artificial herbaceous or woody plants including stems, leaves, flowers, blossoms, buds, blooms, cones, or roots, taken singly or in combination, or in groupings of such portions such as a bouquet or a floral grouping.

The term “propagule” when used herein means any structure capable of being propagated or acting as an agent of reproduction including seeds, shoots, stems, runners, tubers, plants, leaves, roots, or spores.

As indicated above, it will be understood by a person of ordinary skill in the art that equipment and devices for forming sleeves are commercially available, and are well known to a person of ordinary skill in the art. Further detailed discussion of the construction of the sleeves 10-10g described herein therefore is not deemed necessary. However, briefly, the sleeves 10-10g described herein may be formed by intermittently advancing two separate webs, one or two webs preformed in the form of a tube, or a single web folded double and sealing the longitudinal sides and bottom of the two facing panels then cutting the sleeve 10-10g thus formed from the webs or web. Machines which can form sleeves from such single webs or pairs of webs are well within the knowledge of one of ordinary skill in the art.

The floral grouping 36 may be disposed within the sleeve 10-10g along with a suitable ballast material 38 or growing medium described elsewhere herein, or other retaining medium, such as a floral foam. It will also be understood that the floral grouping 36, and any appropriate growing medium or other retaining medium or ballast material 38, may be disposed in the sleeve 10-10g for cultivating the floral grouping 36 or botanical item or for displaying a grown floral grouping 36.

It should be further noted that various features of the versions of the present invention such as various types of lower ends, or manners of securing the sleeves about the floral groupings, perforations, drainage elements, ventilation holes, and types or combinations of material or types or seals may be used alone or in combination as elements of any of the embodiments described above herein.

Changes may be made in the construction and the operation of the various components, elements and assemblies described herein or in the steps or the sequence of steps of the methods described herein without departing from the spirit and scope of the invention as defined in the following claims.

What is claimed is:

1. A sleeve having a flask shape and initially constructed in a flattened condition, the sleeve comprising:
a body having a frustoconical shape, the body having an upper end, a lower end, a sidewall, and an inner space, the sidewall having a first edge and a second edge, the body having a wide diameter between the first edge and the second edge at the lower end, and a narrow diameter between the first edge and the second edge at the upper end; and
a neck extending from the upper end of the body, the neck having an opening in an upper end thereof, the neck open to the inner space of the body; and wherein
the sleeve is openable from the flattened condition to an opened position for holding a floral grouping.

2. The sleeve of claim 1 wherein the lower end of the body has a horizontal transverse seal.

3. The sleeve of claim 1 wherein the lower end of the body has a gusset therein for forming a bottom in the sleeve in the opened position.

4. The sleeve of claim 1 wherein the lower end of the body has a curved lower end.

5. The sleeve of claim 4 wherein the curved lower end has a concave shape.

6. The sleeve of claim 4 wherein the curved lower end has a convex shape.

7. The sleeve of claim 6 wherein the curved lower end has a gusset therein for forming a bottom in the sleeve in the opened position.

8. The sleeve of claim 1 wherein the lower end of the body has a half hexagonal shape.

9. The sleeve of claim 8 wherein the lower end of the body has a gusset for forming a bottom in the sleeve in the opened position.

10. The sleeve of claim 1 having a bonding material on or near the neck for forming a crimped portion in the sleeve.

11. The sleeve of claim 1 wherein the neck has a cylindrical shape in the opened position.

12. The sleeve of claim 1 wherein the neck has a funnel shape in the opened position.

13. A method of containing a floral grouping, comprising:
providing a sleeve having a flask shape, the sleeve comprising:
a body having a frustoconical shape, the body having an upper end, a lower end, a sidewall, and an inner space, the sidewall having a first edge and a second edge, the body having a wide diameter between the first edge and the second edge at the lower end, and a narrow diameter between the first edge and the second edge at the upper end; and
a neck extending from the upper end of the body, the neck having an opening in an upper end thereof, the neck open to the inner space of the body;
opening the sleeve from the flattened condition into an opened position;
disposing a portion of the floral grouping into the inner space of the body of the sleeve, such that a portion of the floral group extends through the opening of the neck and a distance above the upper end of the neck of the sleeve.

14. The method of claim 13 comprising the additional step of disposing a ballast material into the inner space of the body of the sleeve.

15. The method of claim 13 comprising the additional step of forming a constricted area in the neck about a portion of the floral grouping.

16. The method of claim 15 wherein the constricted area in the neck is formed by crimping a bonding material disposed upon a portion of the neck or on a portion of the body near the upper end thereof.

17. The method of claim 15 wherein the constricted area in the neck is formed by placing a banding element about a portion of the sleeve on or near the neck.

18. The method of claim 17 wherein the banding element is an elastic band, a string, a tie, a wire, a ribbon, a heat shrinkable band, a staple, a clip, a plastic tie, a plastic wire, a metal wire, or an adhesive tape.

19. The method of claim 13 wherein in the step of providing a sleeve, the lower end of the body has a horizontal transverse seal.

20. The method of claim 13 wherein in the step of providing a sleeve, the lower end of the body has a gusset therein for forming a bottom in the sleeve in the opened position.

21. The method of claim 13 wherein in the step of providing a sleeve, the lower end of the body has a curved lower end.

22. The method of claim 21 wherein the curved lower end has a concave shape.

23. The method of claim 21 wherein the curved lower end has a convex shape.

24. The method of claim 23 wherein the curved lower end has a gusset therein for forming a bottom in the sleeve in the opened position.

25. The method of claim 13 wherein in the step of providing a sleeve, the lower end of the body has a half hexagonal shape.

26. The method of claim 25 wherein the lower end of the body has a gusset for forming a bottom in the sleeve in the opened position.

27. The method of claim 13 wherein in the step of providing a sleeve, the neck has a cylindrical shape in the opened position.

28. The method of claim 13 wherein in the step of providing a sleeve, the neck has a funnel shape in the opened position.
